(19) United States
(12) Patent Application Publication
(10) Pub. No.: US 2009/0032766 A1
(43) Pub. Date: Feb. 5, 2009

(54) COMPOSITION AND METHOD FOR SELECTIVELY ETCHING GATE SPACER OXIDE MATERIAL

(75) Inventors: Martha M. Rajaratnam, Ridgefield, CT (US); David D. Bernhard, Kooskia, ID (US); David W. Minsek, New Milford, CT (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 12/089,346

(22) PCT Filed: Oct. 4, 2006
(86) PCT No.: PCT/US2006/038931

§ 371 Date: Jun. 27, 2008

Related U.S. Application Data
(60) Provisional application No. 60/723,775, filed on Oct. 5, 2005.

(51) Int. Cl. C09K 13/00

(52) U.S. Cl. 252/79.1

(57) ABSTRACT

A gate spacer oxide material removal composition and process for at least partial removal of gate spacer oxide material from a microelectronic device having same thereon. The anhydrous removal composition includes at least one organic solvent, at least one chelating agent, a base fluoride:acid fluoride component, and optionally at least one passivator. The composition achieves the selective removal of gate spacer oxide material relative to polysilicon and silicon nitride from the vicinity of the gate electrode on the surface of the microelectronic device with minimal etching of metal silicide interconnect material species employed in the gate electrode architecture.

### FIELD OF THE INVENTION

The present invention relates to an anhydrous composition and method for at least partial removal of gate spacer oxide material from microelectronic devices, wherein the anhydrous compositions have a high selectivity for the gate spacer oxide material relative to both poly-silicon, silicon nitride and silicided interconnect materials.

### DESCRIPTION OF THE RELATED ART

With the continued demand for improved device performance there is a continued emphasis on decreasing device dimensions, which provides the dual advantages of dramatically increasing device density as well as improving device performance. Device performance is improved because decreased device dimensions results in shorter paths that need to be traveled by charge carriers, e.g., electrons.

For example, Metal-Oxide-Semiconductor Field-Effect Transistors (MOSFET) gate electrodes have as electrical points of contact the gate surface and the source and drain regions. The distance between the source and drain regions forms the channel length of the gate electrode, and as such, by decreasing device dimensions the channel length is concomitantly decreased. The result is that the switching speed of the device is increased.

It is self evident that reducing device dimensions results in increased packaging density of devices on a microelectronic device chip. This increased packaging density brings with it sharp reductions in the length of the interconnect paths between devices, which reduces the relative negative impact (such as resistive voltage drop, cross talk or RC delay) that these interconnect paths have on overall device performance.

Such requirements however cause problems of increased parasitic capacitance, device contact resistance (gate, source and drain contacts in MOSFET devices), and tight tolerance of pattern definition. For very small sub-micron or sub-half-micron or even sub-quarter-micron modern silicon devices, the conventional photolithographic technique for patterning contacts will not meet the required tolerance of critical dimensions. Methods that have been explored to improve resolution and feature size include the formation of a self-aligned poly-silicon (poly-Si) gate structure, which helps to solve the problem of critical dimension tolerance. Using this method, the contact points that are formed for the source and the drain of the gate electrode self-align with the poly-Si gate.

For example, U.S. Pat. No. 6,864,143 in the name of Shue et al. describes a method of forming a gate electrode using a double layer gate spacer. Referring to FIG. 1A, which is a reproduction of FIG. 10 of the Shue et al. patent, the double layer gate spacer includes first layer 42, such as a chemical vapor deposition (CVD) oxide from a tetraethyl orthosilicate (TEOS) source, and second layer 44, which may be a silicon nitride layer. The gate spacer is deposited and anisotropically etched in steps to conform to the walls of the gate electrode 40, 41. Following deep ion implantation to form source 52 and drain 54 regions, deposition of cobalt, annealing and removal of unreacted cobalt, CoSi₂ interconnect layers 60, 62 and 64 remain.

Silicides are universally applied in many of today's high-density MOSFET devices such as the one illustrated in FIG. 1A. Commonly used silicides include TiSi₂, NiSi, and CoSi₂. Of these, two materials, CoSi₂ and NiSi are the most promising for the formation of silicided layers of contact, especially for the extremely small device CD's that will be required in future devices.

The preferred aspect of the present invention relates to the removal of a portion of the exposed first layer 42, both in the region of silicided interconnect layer 60 and in the drain and source regions, to form “notches,” as illustrated schematically in FIG. 1B. Accordingly, the removal composition must selectively etch silicon oxide material relative to both silicon nitride (44) and poly-silicon (40) as well as inhibit corrosion of the silicided material (60, 62, 64). Although not wishing to be bound by theory, the notches are thought to decrease the transistor leakage.

Towards that end, one object of the present invention to provide improved removal compositions for the selective removal of gate spacer oxide materials relative to poly-silicon and silicon nitride materials while minimizing the corrosion of metal silicide materials that are present.

Another object of the invention relates to improved removal compositions for at least partial removal of gate spacer oxide materials from the vicinity of a gate electrode, said gate electrode optionally including metal silicided interconnect materials, whereby said removal composition selectively etches said gate spacer oxide material relative to poly-silicon and silicon nitride materials while minimizing the corrosion of the metal silicide materials.

### SUMMARY OF THE INVENTION

The present invention relates generally to etching compositions comprising a base fluoride:acid fluoride component, preferably an anhydrous etching composition comprising a base fluoride:acid fluoride component, and process for at least partial removal of gate spacer oxide material from microelectronic devices having same thereon. The anhydrous etching composition includes organic solvent(s), chelating agent(s), optionally passivator(s) and a base fluoride:acid fluoride component.

In one aspect, the invention relates to a gate spacer oxide material removal composition, comprising at least one organic solvent, at least one chelating agent, and a base fluoride:acid fluoride component having a ratio of about 1:1 to about 10:1, wherein the removal composition is substantially devoid of water, and wherein said removal composition is suitable for selectively removing gate spacer oxide material relative to both polysilicon and silicon nitride from a microelectronic device having such material thereon.

In another aspect, the invention relates to a gate spacer oxide material removal composition, comprising at least one organic solvent, at least one chelating agent, at least one passivator, and a base fluoride:acid fluoride component having a ratio of about 1:1 to about 10:1, wherein the removal composition is substantially devoid of water, and wherein said removal composition is suitable for selectively removing gate spacer oxide material relative to both polysilicon and silicon nitride from a microelectronic device having such material thereon.

In another aspect, the invention relates to a kit comprising, in one or more containers, gate spacer oxide material removal composition reagents, wherein said removal composition comprises at least one organic solvent, at least one chelating agent, a base fluoride:acid fluoride component having a ratio of about 1:1 to about 10:1, and optionally at least one passivator, and wherein the kit is adapted to form the removal composition suitable for selectively removing gate spacer oxide material relative to both polysilicon and silicon nitride from a microelectronic device having such material thereon.

In a further aspect, the present invention relates to method of removing gate spacer oxide material from a microelectronic device having said material thereon, said method comprising contacting the microelectronic device with a removal composition for sufficient time to at least partially remove said gate spacer oxide material from the microelectronic device, wherein the removal composition includes at least one organic solvent, at least one chelating agent, and a base fluoride:acid fluoride component having a ratio of about 1:1 to about 10:1, wherein said removal composition is substantially devoid of water, and wherein said removal composition is suitable for selectively removing gate spacer oxide material relative to both polysilicon and silicon nitride from a microelectronic device having such material thereon.

Another aspect of the invention relates to a gate spacer oxide material removal composition, comprising at least one organic solvent, at least one chelating agent, and a base fluoride:acid fluoride component having a ratio of about 1:1 to about 10:1, wherein said removal composition is substantially devoid of water and said removal composition is suitable for selectively removing gate spacer oxide material relative to both polysilicon and silicon nitride from a microelectronic device having such material thereon, and wherein said composition is characterized by at least one of the following (I), (II), (III), (IV), and (V):
(I) the selectivity of gate spacer oxide material relative to polysilicon is about 100:1 to about 300:1;
(II) the selectivity of gate spacer oxide material relative to silicon nitride is about 75:1 to about 150:1;
(III) the pH is in a range from about 3 to about 6 when measured at a 20:1 dilution of water-to-removal composition;
(IV) the at least one chelating agent comprises a glycol ether selected from the group consisting of tripropylene glycol methyl ether (TPGME), propylene glycol n-propyl ether, dipropylene glycol n-propyl ether (DPGPE), tripropylene glycol n-propyl ether, propylene glycol n-butyl ether, dipropylene glycol n-butyl ether (DPGBE), and combinations thereof; and
(V) the removal composition further comprises at least one passivating agent.

Still another aspect of the invention relates to a method of selectively removing a silicon dioxide material from a microelectronic device having same thereon, said method comprising contacting the microelectronic device with a removal composition for sufficient time to remove said silicon dioxide material from the microelectronic device, wherein the removal composition includes at least one organic solvent, at least one chelating agent, and a base fluoride:acid fluoride component having a ratio of about 1:1 to about 10:1, wherein said removal composition is substantially devoid of water, and wherein said microelectronic device further comprises a material selected from the group consisting of polysilicon, silicon nitride, metal, metal alloys and metal silicide.

Another aspect of the invention relates to an article of manufacture comprising a removal composition, a microelectronic device, and material selected from the group consisting of silicon oxide material, polysilicon, silicon nitride material, and combinations thereof, wherein the removal composition includes at least one organic solvent, at least one chelating agent, and a base fluoride:acid fluoride component having a ratio of about 1:1 to about 10:1, and wherein said removal composition is substantially devoid of water.

In a further aspect, the present invention relates to a method of manufacturing a microelectronic device, said method comprising contacting the microelectronic device with a removal composition for sufficient time to at least partially remove silicon oxide-containing material from the microelectronic device having said material thereon, wherein the removal composition includes at least one organic solvent, at least one chelating agent, and a base fluoride:acid fluoride component having a ratio of about 1:1 to about 10:1, and wherein said removal composition is substantially devoid of water.

Yet another aspect of the invention relates to improved microelectronic devices, and products incorporating same, made using the methods of the invention comprising the removal of silicon oxide-containing material from the microelectronic device having said material thereon, using the methods and/or compositions described herein, and optionally, incorporating the microelectronic device into a product.

Other aspects, features and embodiments of the invention will be more fully apparent from the ensuing disclosure and appended claims.

### BRIEF DESCRIPTION OF THE DRAWINGS

FIG. 1A is a cross section of the prior art MOSFET gate electrode after the unreacted cobalt was removed from the surface of the microelectronic device.

FIG. 1B is a cross section of the prior art gate electrode illustrating the “notches” that are etchingly removed using the compositions of the present invention.

FIG. 2 illustrates the etch rate of cobalt silicide as a function of the concentration of the reducing agent ascorbic acid.

FIG. 3 illustrates the etch rate of cobalt silicide as a function of the concentration of the passivator 3-amino-9-mercapto-1,2,4-triazole.

FIG. 4 illustrates the etch rate of cobalt silicide as a function of temperature using a composition including 1 wt. % 1,3-propylene-diamine-N,N,N′,N′-tetraacetic acid (1,3-PDTA).

FIG. 5 illustrates the etch rate of cobalt silicide as a function of temperature using a composition including 1 wt. % ethylenediamine-N,N,N′,N′-tetraacetic acid (EDTA).

FIG. 6 illustrates the etch rate of cobalt silicide as a function of temperature using a composition including 2 wt. % N,N-iminodiacetic acid (IDA).

### DETAILED DESCRIPTION OF THE INVENTION, AND PREFERRED EMBODIMENTS THEREOF

One aspect of the present invention relates to anhydrous compositions that selectively remove silicon oxide deposited from a silicon oxide precursor source relative to both polysilicon (poly-Si) and silicon nitride materials, and hence are useful as etchants for at least partial removal of gate spacer oxide material from a microelectronic device, said compositions optionally including a passivator species to reduce etching of metal silicide interconnector material.

For ease of reference, “microelectronic device” corresponds to semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate that includes a negative channel metaloxide semiconductor (nMOS) and/or a positive channel metaloxide semiconductor (pMOS) transistor and will eventually become a microelectronic device or microelectronic assembly.

As used herein, a “gate spacer” is defined as the material that is formed over the sidewalls of a gate electrode and may include multiple layers selected from the group consisting of silicon nitride, CVD oxide from a TEOS source, silicon oxide, boron-silicate glass (BSG), phosphosilicate glass (PSG), and combinations thereof. Preferably, the gate spacer is a multiple layer structure including a first oxide layer that conforms to the walls of the gate electrode and a second nitride layer, as described hereinabove. It should be appreciated that the gate spacer may include more or less than two layers as required for the specific gate electrode design. The gate spacer acts as a mask material to define the drain and source regions of the pMOS and NMOS during ion implantation and may include a silicided interconnect layer.

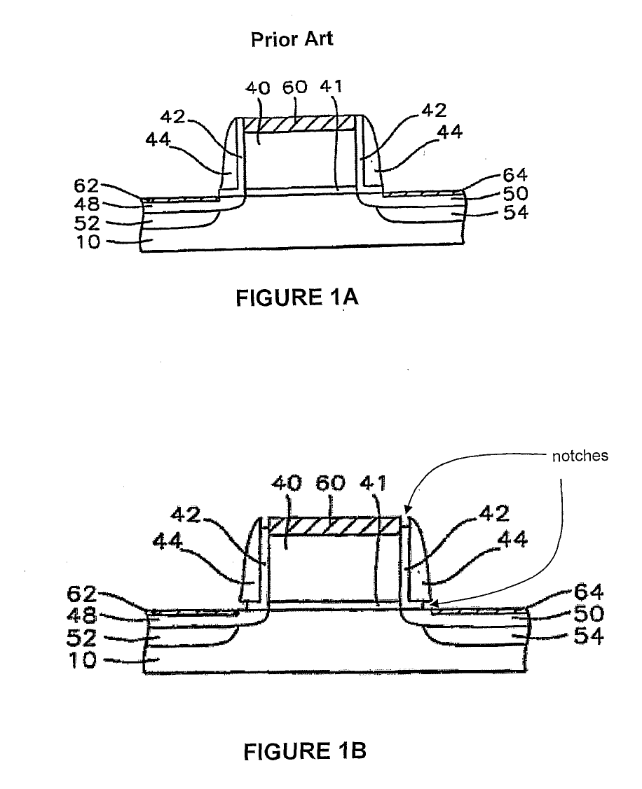

As used herein, “at least partial removal of gate spacer oxide material” corresponds to the removal of at least a portion of exposed oxide layer of the gate spacer. Specifically, at least a portion of the exposed oxide layer is etchingly removed relative to the surrounding silicon nitride, poly-silicon and/or silicide layers so that a “notch” is formed (see, e.g., FIG. 1B). In a preferred embodiment of the invention, at least about 1% to about 20% of the total mass of first oxide layer material is notched using the compositions of the present invention, more preferably about 5% to about 10%, while less than 5%, more preferably less than 2%, even more preferably less than 1% of the total mass of the poly-silicon, silicon nitride and/or silicided interconnect material exposed to the composition are removed. Although the present invention relates to at least partial removal of gate spacer oxide material from the microelectronic device, i.e., “notching,” it is also contemplated herein that the compositions of the present invention may be used more generally to substantially remove silicon oxide material relative to poly-silicon and/or silicon nitride layers. In those circumstances, “substantial removal” is defined as preferably at least 90%, more preferably at least 95%, and most preferably at least 99% of the silicon oxide material is removed using the compositions of the invention.

As used herein, “about” is intended to correspond to +5% of the stated value.

As used herein, “suitability” for removing gate spacer oxide material from a microelectronic device having such oxide material thereon corresponds to at least partial removal of gate spacer oxide material from the microelectronic device.

As used herein, the ratio of base fluoride to acid fluoride corresponds to the amount of ammonium fluoride (NH₄F) to hydrogen fluoride (HF) in the composition. Preferably, the base fluoride to acid fluoride ratio is produced by the combination of an appropriate amount of ammonium fluoride and ammonium bifluoride (NH₄HF₂) (for personnel safety), i.e., no HF is added to the composition, however, it is contemplated herein that said ratio may be produced by combining NH₄F and HF in the correct ratios with the understanding that when HF is actively included, the composition may include an aqueous component. In addition, alternative base fluoride salts are contemplated herein, e.g., NR¹R²R³R⁴F, wherein R¹, R², R³ and R⁴ may be the same as or different from one another and may be hydrogen, C₁-C₆ alkyls, e.g., methyl, ethyl, and straight-chained or branched propyl, butyl, propyl and hexyl, and/or substituted or unsubstituted C₆-C₁₀ aryls, e.g., benzyl, for combination with the ammonium bifluoride species to yield the base fluoride:acid fluoride component.

As described herein, the silicon oxide layer is preferably deposited from a silicon-oxide precursor source, e.g., TEOS.

As defined herein, “anhydrous” corresponds to a composition having less than 5 wt. % water therein, preferably less than 2 wt. %, more preferably less than 1 wt. %, and most preferably less than 0.5 wt. %. As defined herein, “substantially devoid” is defined as less than 2 wt. %, preferably less than 1 wt. %, more preferably less than 0.5 wt. %, and most preferably less than 0.1 wt. %.

Importantly, the anhydrous compositions of the present invention must possess good metal compatibility, e.g., a low etch rate on the interconnect metal and/or interconnector metal silicide material. Metals of interest include, but are not limited to, copper, tungsten, cobalt, aluminum, tantalum, titanium and ruthenium.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In one aspect, the present invention relates broadly to an anhydrous composition for removing gate spacer oxide material from the surface of a microelectronic device having same thereon, said composition including at least one organic solvent and a base fluoride:acid fluoride ratio of about 1:1 to about 10:1, wherein the anhydrous composition is substantially devoid of water. More preferably, the present invention relates to an anhydrous composition for removing gate spacer oxide material from the surface of a microelectronic device having same thereon, said composition including at least one organic solvent, at least one chelating agent, a base fluoride:acid fluoride ratio of about 1:1 to about 10:1, and optionally at least one passivator, wherein the anhydrous composition is substantially devoid of water. Even more preferably, the present invention relates to an anhydrous composition for removing gate spacer oxide material from the surface of a microelectronic device having same thereon, said composition including at least one organic solvent, at least one chelating agent, at least one passivator, and a base fluoride:acid fluoride ratio of about 1:1 to about 10:1, wherein the anhydrous composition is substantially devoid of water. In one embodiment, the components of the anhydrous composition are present in the following ranges, based on the total weight of the composition.

| component | % by weight |
|---|---|
| organic solvent(s) | about 5 to about 95% |
| chelating agent(s) | about 0.01% to about 50% |
| passivator | 0% to about 5% |
| base fluoride:acid fluoride component | 0.01 to about 10% |

In all embodiments, preferably the base fluoride:acid fluoride ratio is about 2:1 to about 5:1, more preferably about 2.5:1 to about 3.5:1. When passivator is present, the preferred range is about 0.01 wt. % to about 5 wt. %, based on the total weight of the composition.

In the broad practice of the invention, the anhydrous composition may comprise, consist of, or consist essentially of: (i) at least one organic solvent and a base fluoride:acid fluoride ratio of about 1:1 to about 10:1, wherein the anhydrous composition is substantially devoid of water; (ii) at least one organic solvent, at least one chelating agent, a base fluoride:acid fluoride ratio of about 1:1 to about 10:1, wherein the anhydrous composition is substantially devoid of water; or (iii) at least one organic solvent, at least one chelating agent, at least one passivator and a base fluoride:acid fluoride ratio of about 1:1 to about 10:1, preferably about 2:1 to about 5:1, more preferably about 2.5:1 to about 3.5:1, wherein the anhydrous composition is substantially devoid of water. In general, the specific proportions and amounts of organic solvent(s), chelating agent(s), passivator(s) and base fluoride:acid fluoride component, in relation to each other, may be suitably varied to provide the desired etching action of the anhydrous composition for the gate spacer oxide material and/or processing equipment, as readily determinable within the skill of the art without undue effort. Preferably, the anhydrous composition of the invention is substantially devoid of oxidizer, carbonate species, fluoboric acid, water, and sulfoxide species.

The anhydrous compositions of the invention selectively etch gate spacer oxide material relative to both poly-Si and silicon nitride from the surface of the microelectronic device without causing substantial corrosion of the metal and/or metal silicide interconnect material(s).

In a preferred embodiment, the present invention relates to an anhydrous composition for removing gate notch spacer oxide material from the surface of a microelectronic device having same thereon, said composition including at least one organic solvent, at least one glycol ether chelating agent, at least one passivator and a base fluoride:acid fluoride component having a ratio of about 2.5:1 to about 3.5:1.

The range of mole ratios for organic solvent(s) relative to base fluoride:acid fluoride component is about 1:1 to about 30:1, preferably about 10:1 to about 15:1, the range of mole ratios for organic solvent(s) relative to chelating agent(s) is about 1:1 to about 30:1, preferably about 10:1 to about 16:1, and the range of mole ratios for organic solvent(s) relative to passivator(s), when present, is about 100:1 to about 200:1, preferably about 150:1 to about 175:1.

Compositions of the invention have a pH value in a range from about 1 to about 6.9, preferably about 3 to about 6, more preferably about 4 to about 5, when measured at a 20:1 dilution of water-to-etchant composition.

Compositions of the present invention have a selectivity of gate spacer oxide material (e.g., silicon dioxide) relative to polysilicon of about 100:1 to about 300:1, more preferably about 200:1 to about 300:1 at 30° C., and a selectivity of gate spacer oxide material (e.g., silicon dioxide) relative to silicon nitride of about 75:1 to about 150:1, more preferably about 100:1 to about 150:1, at 30° C. In addition, the compositions of the present invention have a silicide material etch rate of about 6 Å per minute to about 10 Å per minute at 30° C.

The organic solvent species preferably is capable of promoting the generation of HF when ammonium bifluoride is dissolved therein. Suitable organic solvent species for such composition include, without limitation: ketones such as acetone, 2-butanone, 2-pentanone, and 3-pentanone; ethers such as tetrahydrofuran; amines such as monoethanolamine, triethanolamine, triethylenediamine, methylethanolamine, methyldiethanolamine, pentamethyldiethylenetriamine, dimethyldiglycolamine, 1,8-diazabicyclo[5.4.0]undecene, aminopropylmorpholine, hydroxyethylmorpholine, aminoethylmorpholine, hydroxypropylmorpholine, diglycolamine, N-methylpyrrolidinone (NMP), N-octylpyrrolidinone, N-phenylpyrrolidinone, cyclohexylpyrrolidinone, vinyl pyrrolidinone; amides such as formamide, dimethylformamide, acetamide, dimethylacetamide; sulfur-containing solvents such as tetramethylene sulfone and dimethyl sulfoxide; alcohols such as ethanol, propanol, butanol, and higher alcohols; glycols such as ethylene glycol, propylene glycol (1,2-propanediol), neopentyl glycol, and benzyl diethylene glycol (BzDG); polyglycols such as diethylene glycol and higher polyethylene glycols, dipropylene glycol and higher polypropylene glycols, glycol ethers and polyglycol ethers, and glycerol; and combinations thereof. Preferably, the organic solvent species includes ethylene glycol.

Surprisingly, the present inventors discovered that the selectivity of the anhydrous composition for SiO₂ relative to poly-Si and/or silicon nitride was greatly improved by the inclusion of the chelating agent. Suitable chelating agent(s) may be of any suitable type, and may include, without limitation, polyethylene ethers (PEGs), glycol ethers such as diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether (TPGME), propylene glycol monoethyl ether, propylene glycol n-propyl ether, dipropylene glycol n-propyl ether (DPGPE), tripropylene glycol n-propyl ether, propylene glycol n-butyl ether, dipropylene glycol n-butyl ether (DPGBE), tripropylene glycol n-butyl ether, propylene glycol phenyl ether (phenoxy-2-propanol) and combinations thereof. Preferably, the chelating agent includes TPGME, DPGPE, DPGBE or combinations thereof.

Suitable passivators include, but are not limited to, triazoles, such as 1,2,4-triazole, or triazoles substituted with substituents such as C₁-C₈ alkyl, amino, thiol, mercapto, imino, carboxy and nitro groups, such as benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, and the like, as well as thiazoles, tetrazoles, imidazoles, phosphates, thiols and azines such as 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, indiazole, etc. Suitable passivator species further include glycerols, amino acids, carboxylic acids, alcohols, amides such as ethylenediaminetetraacetic acid (EDTA), 1,2-cyclohexanediamine-N,N,N′,N′-tetraacetic acid (CDTA) and 1,3-propylene-diamine-N,N,N′,N′-tetraacetic acid (1,3-PDTA), and quinolines such as guanine, adenine, glycine, glycerol, thioglycerol, nitrilotriacetic acid, salicylamide, iminodiacetic acid (IDA), benzoguanamine, melamine, thiocyranuric acid, anthranilic acid, gallic acid; ascorbic acid; salicylic acid; 8-hydroxyquinoline, 5-carboxylic acid-benzotriazole, 3-mercaptopropanol, boric acid, etc. Preferably, the passivator includes IDA. The passivator is usefully employed to increase the compatibility of the composition with the metals and metal silicide materials associated with the gate electrode of the microelectronic device.

The base fluoride:acid fluoride component, having a ratio of base fluoride to acid fluoride of about 1:1 to about 10:1, includes a combination of fluoride-containing species in the appropriate amounts to yield said base fluoride:acid fluoride ratio. For example, ammonium fluoride and ammonium bifluoride may be combined to yield the appropriate NH₄F:HF ratio, as readily determined by one skilled in the art. Alternatively, the base fluoride may be a quaternary ammonium fluoride species such as NR¹R²R³R⁴F, wherein R¹, R², R³ and R⁴ may be the same as or different from one another and may be hydrogen and C₁-C₆ alkyls, e.g., methyl, ethyl, and straight-chained or branched propyl, butyl, propyl and hexyl. Although less favorable, ammonium fluoride may be combined with hydrogen fluoride to yield the desired ratio of base fluoride to acid fluoride species.

In various preferred embodiments, the anhydrous composition of the invention includes the following components present in the following ranges, based on the total weight of the formulation:

| | | preferably | most preferably |
|---|---|---|---|
| component of | % by weight | (% by weight) | (% by weight) |
| organic solvent(s) | about 5% to | about 44% to | about 70% to |
| | about 95% | about 95% | about 85% |
| chelating agent(s) | about 0.01% to | about 1% to | about 10% to |
| | about 50% | about 40% | about 30% |
| passivator(s) | about 0.01% to | about 0.1% to | about 0.1% to |
| | about 5% | about 3% | about 1.5% |
| base fluoride:acid | about 0.01% to | about 1% to | about 3% to |
| fluoride | about 10% | about 8% | about 7% |

Such compositions may optionally include additional components, including active as well as inactive ingredients, e.g., surfactants, stabilizers, reducing agents (e.g., ascorbic acid), dispersants, etchants, and other additives known to those skilled in the art.

In a particularly preferred embodiment of the present invention, the anhydrous composition includes about 3 wt. % to about 5 wt. % of 2:1 to about 4:1 base fluoride:acid fluoride component, IDA, ethylene glycol and a chelating agent comprising glycol ether selected from the group consisting DPGBE, DPGPE, TPGME, and combinations thereof. In a particularly preferred embodiment, the chelating agent comprises DPGBE.

In yet another embodiment, the anhydrous composition of the present invention includes at least one organic solvent, at least one chelating agent, at least one passivator, a base fluoride:acid fluoride ratio of about 1:1 to about 10:1, preferably about 2:1 to about 5:1, more preferably about 2.5:1 to about 3.5:1, and gate spacer oxide residue material, wherein the gate spacer oxide residue comprises silicon-containing species. Importantly, the residue material may be dissolved and/or suspended in the anhydrous composition of the invention.

The anhydrous compositions of the invention are easily formulated by simple addition of the respective ingredients and mixing to homogeneous condition. Furthermore, the anhydrous compositions may be readily formulated as single-package formulations or multi-part formulations that are mixed at the point of use. The individual parts of the multi-part formulation may be mixed at the tool or in a storage tank upstream of the tool. The concentrations of the respective ingredients may be widely varied in specific multiples of the anhydrous composition, i.e., more dilute or more concentrated, in the broad practice of the invention, and it will be appreciated that the anhydrous compositions of the invention can variously and alternatively comprise, consist or consist essentially of any combination of ingredients consistent with the disclosure herein. One embodiment of the invention relates to concentrated formulations containing less than 75 wt % of the solvent to be used in the final formulation, or less than 50%, or less than 25%, or no solvent. Such concentrated formulations are then diluted with additional solvent at the fab and/or prior to use at the fab.

Accordingly, another aspect of the invention relates to a kit including, in one or more containers, one or more components adapted to form the anhydrous compositions of the invention. Preferably, the kit includes, in one or more containers, organic solvent(s), chelating agent(s), passivator(s) and the fluoride-containing components. Alternatively, the kit includes, in one or more containers, chelating agent(s), passivator(s) and the fluoride-containing components for combining with said organic solvent(s) at the fab. In yet another alternative, the kit includes, in one or more containers, organic solvent(s), chelating agent(s), and passivator(s) for combining with the fluoride-containing components at the fab. It will be appreciated by one skilled in the art that other combinations are contemplated herein. The containers of the kit must be suitable for storing and shipping said cleaning composition components, for example, NOWPak® containers (Advanced Technology Materials, Inc., Danbury, Conn., USA).

In yet another aspect, the invention relates to methods of etching gate spacer oxide material (i.e., notching) from the surface of the microelectronic device having same thereon using the anhydrous compositions described herein. For example, gate spacer oxide material may be removed without substantially damaging metal and metal silicide interconnect materials. Alternatively, the invention relates to methods of selectively and substantially removing silicon oxide materials relative to polysilicon and/or silicon nitride materials from the surface of the microelectronic device having same thereon using the anhydrous compositions described herein.

In etching application, the anhydrous composition is applied in any suitable manner to the surface of the microelectronic device having the gate spacer oxide material thereon, e.g., by spraying the anhydrous composition on the surface of the device, by dipping (in a static or dynamic volume of the anhydrous composition) of the device including the gate spacer oxide material, by contacting the device with another material, e.g., a pad, or fibrous sorbent applicator element, that has the anhydrous composition absorbed thereon, by contacting the device including the gate spacer oxide material with a circulating anhydrous composition, or by any other suitable means, manner or technique, by which the anhydrous composition is brought into removal contact with the gate spacer oxide material.

Yet another aspect of the invention relates to microelectronic devices manufactured using the compositions and methods described herein.

The compositions of the present invention, by virtue of their selectivity for gate spacer oxide material relative to other materials that may be present on the microelectronic device structure and exposed to the anhydrous composition, such as metallization, polysilicon, silicon nitride, etc., achieve at least partial removal of the gate spacer oxide material in a highly efficient and highly selective manner.

In use of the compositions of the invention for removing gate spacer oxide material from microelectronic device structures having same thereon, the anhydrous composition typically is contacted with the gate electrode structure for a time of from about 30 seconds to about 45 minutes, preferably about 1 to 30 minutes, at a temperature in a range of from about 10° C. to about 50° C., preferably about 20° C. to about 30° C. Such contacting times and temperatures are illustrative, and any other suitable time and temperature conditions may be employed that are efficacious to at least partially remove the gate spacer oxide material from the device structure to form the desired “notches,” within the broad practice of the invention.

Rates of CoSi₂ removal are preferably in a range from about 0.01 Å min⁻¹ to about 15 Å min⁻¹, more preferably about 0.01 Å min⁻¹ to about 10 Å min⁻¹.

Following the achievement of the desired removal action, the anhydrous composition is readily removed from the microelectronic device to which it has previously been applied, e.g., by rinse, wash, or other removal step(s), as may be desired and efficacious in a given end use application of the compositions of the present invention. For example, the device may be rinsed with a rinse solution including deionized water and/or dried (e.g., spin-dry, N₂, vapor-dry etc.).

The features and advantages of the invention are more fully shown by the illustrative examples discussed below.

### Example 1

Subsequent to determining that anhydrous compositions were superior to hydrous compositions in terms of the selectivity of silicon oxide relative to both poly-Si and silicon nitride, the etch rate of silicon oxide, poly-Si and silicon nitride was determined using anhydrous compositions having varying base fluoride:acid fluoride component ratios.

The samples tested included 1 cm² blanketed silicon oxide, poly-Si and silicon nitride, which were first measured using an optical interferometer (Nanospec) to determine the pre-immersion thickness, followed by individually immersing each wafer in approximately 50 mL of clean anhydrous composition, rinsing with deionized water, blowing dry with nitrogen and post-immersion measuring using the optical interferometer to determine the change in thickness to derive the etch rate of silicon oxide, poly-Si and silicon nitride in each composition. Silicon oxide was etched for 10 minutes whereas poly-Si and silicon nitride were etched for 30 minutes.

The anhydrous compositions tested included A1-A4, as listed hereinbelow in Table 1.

TABLE 1
Anhydrous compositions A1-A4.

| | NH₄HF₂/ | NH₄F/ | | TPGME/ | IDA/ | |
|---|---|---|---|---|---|---|
| Solution | wt. % | wt. % | NH₄F:HF | wt. % | wt. % | EG/wt. % |
| A1 | 0.91 | 4.09 | 10:1 | 2 | 1 | 92 |
| A2 | 0.91 | 4.09 | 10:1 | 2 | 0 | 93 |
| A3 | 1.667 | 3.333 | 5:1 | 2 | 1 | 92 |
| A4 | 1.667 | 3.333 | 5:1 | 2 | 0 | 93 |

The etch rates and the selectivity of anhydrous compositions A1-A4 at both 20° C. and 30° C. are tabulated in Table 2 hereinbelow.

TABLE 2
Etch rates of silicon oxide, poly-Si and Si₃N₄ using compositions A1-A4.

| | | | | | selectivity | |
|---|---|---|---|---|---|---|
| | | silicon oxide | Poly-Si etch | Si₃N₄ etch | silicon | Selectivity |
| | | etch rate/ | rate/ | rate/ | oxide:poly- | silicon |
| Solution | Temperature | Å min⁻¹ | Å min⁻¹ | Å min⁻¹ | Si | oxide:Si₃N₄ |
| A1 | 20° C. | 77.56 | 1.69 | 0.76 | 46:1 | 102:1 |
| | 30° C. | 199 | 3.37 | 1.41 | 59:1 | 141:1 |
| A2 | 20° C. | 62.45 | 1.57 | 0.596 | 40:1 | 105:1 |
| | 30° C. | 163 | 3.48 | 1.13 | 47:1 | 144:1 |
| A3 | 20° C. | 110.31 | 1.75 | 1.06 | 63:1 | 104:1 |
| | 30° C. | 270 | 3.67 | 2.15 | 74:1 | 126:1 |
| A4 | 20° C. | 96 | 1.73 | 0.84 | 55:1 | 114:1 |
| | 30° C. | 263 | 3.46 | 1.77 | 76:1 | 148:1 |

It can be seen that the 5:1 base fluoride:acid fluoride ratio (solutions A3 and A4) resulted in better silicon oxide selectivity than the corresponding 10:1 ratio. Further, the wafers processed at 30° C. resulted in a higher silicon oxide selectivity than the ones processed at 20° C. Accordingly, all experiments introduced hereinafter were performed at 30° C. unless noted otherwise.

### Example 2

Based on the results from Example 1, the base fluoride:acid fluoride ratio was further decreased and the ratio of TPGME to EG was varied. The experiments outlined in Example 1 were repeated for blanketed silicon oxide and poly-Si at 30° C. Silicon oxide was etched for 10 minutes whereas poly-Si was etched for 30 minutes.

The anhydrous compositions tested included B1-B4, as listed hereinbelow in Table 3.

TABLE 3
Anhydrous compositions B1-B4.

| | NH₄HF₂/ | NH₄F/ | | TPGME/ | IDA/ | |
|---|---|---|---|---|---|---|
| Solution | wt. % | wt. % | NH₄F:HF | wt. % | wt. % | EG/wt. % |
| B1 | 2.5 | 2.5 | 3:1 | 0 | 0 | 95 |
| B2 | 2.5 | 2.5 | 3:1 | 2 | 1 | 92 |
| B3 | 2.5 | 2.5 | 3:1 | 6 | 1 | 88 |
| B4 | 2.5 | 2.5 | 3:1 | 10 | 1 | 84 |

The etch rates and the selectivity of anhydrous compositions B1-B4 at 30° C. are tabulated in Table 4 hereinbelow.

TABLE 4
Etch rates of silicon oxide and poly-Si using compositions B1-B4.

| | silicon oxide | Poly-Si etch | selectivity |
|---|---|---|---|
| | etch rate/ | rate/ | silicon |
| Solution | Å min⁻¹ | Å min⁻¹ | oxide:poly-Si |
| B1 | 259.5 | 3.65 | 71:1 |
| B2 | 274.6 | 3.41 | 81:1 |
| B3 | 270.4 | 3.0 | 90:1 |
| B4 | 279.3 | 2.71 | 103:1 |

It can be seen that the higher the amount of glycol ether (TPGME) in the composition the greater the silicon oxide etch selectivity. In addition, comparing composition A3 with B2, it can be seen that the reduction of the base fluoride:acid fluoride ratio from 5:1 to 3:1, respectively, resulted in an increase in silicon oxide etch selectivity. Accordingly, all compositions introduced hereinafter had a base fluoride:acid fluoride ratio of 3:1 unless noted otherwise.

### Example 3

Based on the results from Examples 1 and 2, various glycol ethers and other chelators were tested at various concentrations to determine the optimum chelator to add to said anhydrous composition. The experiments outlined in Example 1 were repeated for blanketed silicon oxide, poly-Si and silicon nitride at 30° C. Silicon oxide was etched for 10 minutes whereas poly-Si and silicon nitride were etched for 30 minutes.

The anhydrous compositions tested (C1-C12), each of which included 5 wt. % 3:1 NH₄F:HF and 1 wt. % IDA, are listed hereinbelow in Table 5.

TABLE 5
Anhydrous compositions C1-C12.

| | TPGME/ | DPGPE/ | 400 MWt | butyl | EG/ |
|---|---|---|---|---|---|
| Solution | wt. % | wt. % | PEG/wt. % | carbitol/wt. % | wt. % |
| C1 | 20 | 0 | 0 | 0 | 74 |
| C2 | 0 | 0 | 0 | 2 | 92 |
| C3 | 0 | 0 | 0 | 6 | 88 |
| C4 | 0 | 0 | 0 | 10 | 84 |
| C5 | 0 | 0 | 0 | 20 | 74 |
| C6 | 0 | 2 | 0 | 0 | 92 |
| C7 | 0 | 6 | 0 | 0 | 88 |
| C8 | 0 | 10 | 0 | 0 | 84 |
| C9 | 0 | 20 | 0 | 0 | 74 |
| C10 | 0 | 0 | 1 | 0 | 93 |
| C11 | 0 | 0 | 2 | 0 | 92 |
| C12 | 0 | 0 | 4 | 0 | 90 |

The etch rates and the selectivity of anhydrous compositions C1-C12 at 30° C. are tabulated in Table 6 hereinbelow.

TABLE 6
Etch rates of silicon oxide, poly-Si and Si₃N₄ using compositions C1-C12.

| | | Poly-Si | | selectivity | |
|---|---|---|---|---|---|
| | silicon oxide | etch | Si₃N₄ etch | silicon | Selectivity |
| | etch rate/ | rate/ | rate/ | oxide:poly- | silicon |
| Solution | Å min⁻¹ | Å min⁻¹ | Å min⁻¹ | Si | oxide:Si₃N₄ |
| C1 | 271 | 2.02 | 2.44 | 134:1 | 111:1 |
| C2 | 260 | 3.54 | — | 73:1 | — |
| C3 | 257 | 2.92 | — | 88:1 | — |
| C4 | 268 | 2.67 | — | 100:1 | — |
| C5 | 272 | 2.37 | — | 115:1 | — |
| C6 | 263 | 2.74 | 2.86 | 96:1 | 92:1 |
| C7 | 270 | 1.95 | 2.66 | 139:1 | 102:1 |
| C8 | 262 | 1.67 | 2.81 | 157:1 | 93:1 |
| C9 | 253 | 1.38 | 2.73 | 183:1 | 93:1 |
| C10 | 259 | 4.03 | — | 64:1 | — |
| C11 | 264 | 4.27 | — | 62:1 | — |
| C12 | 263 | 4.47 | — | 59:1 | — |

The results tabulated in Table 6 corroborate the results of Example 2, whereby the higher the amount of glycol ether in the composition the greater the silicon oxide etch selectivity. The order of silicon oxide selectivity as a function of chelator was determined to be DPGPE>TPGME>butyl carbitol>PEG.

### Example 4

Based on the results from Example 3, the concentration of glycol ethers was further varied to determine the optimum amount of glycol ether chelator to add to said anhydrous composition. The experiments outlined in Example 1 were repeated for blanketed silicon oxide and poly-Si at 30° C. Silicon oxide was etched for 10 minutes whereas poly-Si was etched for 30 minutes.

The anhydrous compositions tested (D1-D6), each of which included 5 wt. % 3:1 NH₄F:HF and 1 wt. % IDA, are listed hereinbelow in Table 7.

TABLE 7
Anhydrous compositions D1-D6.

| Solution | TPGME/ wt. % | DPGPE/wt. % | EG/wt. % |
|---|---|---|---|
| D1 | 30 | 0 | 64 |
| D2 | 40 | 0 | 54 |
| D3 | 50 | 0 | 44 |
| D4 | 0 | 30 | 64 |
| D5 | 0 | 40 | 54 |
| D6 | 0 | 50 | 44 |

The etch rates and the selectivity of anhydrous compositions D1-D6 at 30° C. are tabulated in Table 8 hereinbelow.

TABLE 8
Etch rates of silicon oxide and poly-Si using compositions D1-D6.

| | silicon oxide | Poly-Si etch | selectivity |
|---|---|---|---|
| | etch rate/ | rate/ | silicon |
| Solution | Å min⁻¹ | Å min⁻¹ | oxide:poly-Si |
| D1 | 283 | 2.67 | 106:1 |
| D2 | 290 | 2.61 | 111:1 |
| D3 | 287 | 2.61 | 110:1 |
| D4 | 284 | 1.55 | 183:1 |
| D5 | 291 | 1.55 | 191:1 |
| D6 | 282 | 1.55 | 182:1 |

The results tabulated in Table 8 illustrate that the increased amount of glycol ether, i.e., greater than 20 wt. %, whether DPGBE or TPGME, did not result in any significant change in the silicon oxide selectivity. Accordingly, the maximum silicon oxide etch selectivity essentially corresponds to 20 wt. % glycol ether. The results tabulated in Table 8 also corroborate the results of Example 3, whereby the DPGPE is the better glycol ether in terms of increased silicon oxide etch selectivity.

### Example 5

Based on the results from Examples 3 and 4, the chelator DPGBE was added to the anhydrous composition and the silicon oxide etch selectivity compared to the other glycol ethers tested. The experiments outlined in Example 1 were repeated for blanketed silicon oxide, poly-Si and silicon nitride at 30° C. Silicon oxide was etched for 10 minutes whereas poly-Si was etched for 30 minutes.

The anhydrous compositions E1 and E2 included:

### E1

### 5 wt. % 3:1 NH4F:HF

### 20 wt. % DPGBE

### 75 wt. % EG

### E2

### 5 wt. % 3:1 NH4F:HF

### 20 wt. % DPGBE

### 1 wt. % IDA

### 74 wt. % EG

The etch rates and the selectivity of anhydrous composition E1 at 30° C. is tabulated in Table 9 and compared to C1 (20 wt. % TPGME) and C9 (20 wt. % DPGPE) from Table 6.

TABLE 9
Etch rates of silicon oxide, poly-Si, and Si₃N₄ using composition E1.

| | | Poly-Si | | selectivity | |
|---|---|---|---|---|---|
| | silicon oxide | etch | Si₃N₄ etch | silicon | Selectivity |
| | etch rate/ | rate/ | rate/ | oxide:poly- | silicon |
| Solution | Å min⁻¹ | Å min⁻¹ | Å min⁻¹ | Si | oxide:Si₃N₄ |
| E1 | 280.1 | 1.22 | 2.25 | 230:1 | 125:1 |
| C1 | 271 | 2.02 | 2.44 | 134:1 | 111:1 |
| C9 | 253 | 1.38 | 2.73 | 183:1 | 93:1 |

The results tabulated in Table 9 illustrate that the silicon oxide selectivity as a function of glycol ether is DPGBE>DPGPE>TPGME. Moreover, the composition including 20 wt. % DPGBE produced the desired etch selectivity.

A patterned semiconductor device wafer having semi-dense nMOS and pMOS devices thereon was processed with composition E2 at 30° C. for 60 seconds. Although not shown herein, the patterned wafer showed some cobalt silicide corrosion, said corrosion being slightly higher at the pMOS device than at the nMOS device. Increasing the length of processing to 90 seconds concomitantly increased the amount of CoSi₂ corrosion, indicating that at 30° C., 60 seconds is the preferred etch time.

Importantly, the patterned semiconductor device wafer having semi-dense nMOS and pMOS devices thereon was also processed with composition E1 (devoid of IDA passivator) at 30° C. for 60 seconds and 90 seconds. The wafers processed with the E1 composition exhibited more cobalt silicide corrosion than the wafers processed with the E2 composition (having 1 wt. % IDA passivator therein).

### Example 6

When large quantities of the E1 and E2 compositions were formulated, a phase separation was noted indicating that the solubility of DPGBE in the solvent system was not quite 20 wt. %. Accordingly, new compositions were formulated using varying amounts of DPGBE and DPGPE and no passivator. The experiments outlined in Example 1 were repeated for blanketed silicon oxide, poly-Si and silicon nitride at 30° C. Silicon oxide was etched for 10 minutes whereas poly-Si was etched for 30 minutes.

The anhydrous compositions tested (F1-F9), each of which included the indicated weight percent of 3:1 NH₄F:HF and no IDA, are listed hereinbelow in Table 10.

TABLE 10
Anhydrous compositions F1-F9.

| | wt. % 3:1 | DPGBE/ | | |
|---|---|---|---|---|
| Solution | NH₄F:HF | wt. % | DPGPE/wt. % | EG/wt. % |
| F1 | 5 | 15 | 5 | 75 |
| F2 | 5 | 12 | 8 | 75 |
| F3 | 5 | 10 | 10 | 75 |
| F4 | 4 | 15 | 5 | 76 |
| F5 | 4 | 12 | 8 | 76 |
| F6 | 4 | 10 | 10 | 76 |
| F7 | 3 | 15 | 5 | 76 |
| F8 | 3 | 12 | 8 | 76 |
| F9 | 3 | 10 | 10 | 76 |

The etch rates and the selectivity of anhydrous compositions F1-F9 at 30° C. are tabulated in Table 11 hereinbelow.

TABLE 11
Etch rates of silicon oxide, poly-Si and Si₃N₄ using compositions F1-F9.

| | | Poly-Si | | selectivity | |
|---|---|---|---|---|---|
| | silicon oxide | etch | Si₃N₄ etch | silicon | Selectivity |
| | etch rate/ | rate/ | rate/ | oxide:poly- | silicon |
| Solution | Å min⁻¹ | Å min⁻¹ | Å min⁻¹ | Si | oxide:Si₃N₄ |
| F1 | 351.03 | 1.20 | 2.73 | 292:1 | 128:1 |
| F2 | 330.77 | 1.34 | 2.98 | 247:1 | 111:1 |
| F3 | 317.15 | 1.38 | 2.90 | 230:1 | 109:1 |
| F4 | 295.75 | 1.20 | 2.49 | 246:1 | 118:1 |
| F5 | 287.25 | 1.20 | 2.57 | 239:1 | 112:1 |
| F6 | 289.87 | 1.24 | 2.54 | 234:1 | 114:1 |
| F7 | 237.27 | 1.01 | 1.97 | 235:1 | 120:1 |
| F8 | 209.90 | 1.16 | 2.12 | 181:1 | 99:1 |
| F9 | 255.05 | 1.30 | 2.0 | 196:1 | 127:1 |

Importantly, the silicon oxide:poly-Si etch selectivity for composition E1 was similar to compositions F3, F6 and F7. That said, the compositions having the higher ratios of DPGBE to DPGPE exhibited the highest silicon oxide:poly-Si etch selectivity (see, e.g., F1 relative to F2 and F3, etc.). Furthermore, the compositions having 5 wt. % 3:1 NH₄F:HF also exhibited the highest silicon oxide:poly-Si etch selectivity, however, the 4 wt. % 3:1 NH₄F:HF composition was chosen as the base composition to reduce CoSi₂ corrosion.

### Example 7

New compositions were formulated using lower amounts of DPGBE in the 4 wt. % NH₄F:HF base composition which was devoid of passivator. The experiments outlined in Example 1 were repeated for blanketed silicon oxide, poly-Si and silicon nitride at 30° C. silicon oxide was etched for 10 minutes whereas poly-Si was etched for 30 minutes.

The anhydrous compositions tested (G1 and G2), each of which included 4 wt. % 3:1 NH₄F:HF and no IDA, are listed hereinbelow in Table 12.

TABLE 12
Anhydrous compositions G1 and G2.

| Solution | DPGBE/wt. % | DPGPE/wt. % | EG/wt. % |
|---|---|---|---|
| G1 | 15 | 0 | 81 |
| G2 | 12 | 0 | 84 |

The etch rates and the selectivity of anhydrous compositions G1 and G2 at 30° C. are tabulated in Table 13 and compared to F4 (15 wt. % DPGBE and 5 wt. % DPGPE) and F5 (12 wt. % DPGBE and 8 wt. % DPGPE).

TABLE 13
Etch rates of silicon oxide, poly-Si and Si₃N₄
using compositions G1 and G2.

| | | Poly-Si | | selectivity | |
|---|---|---|---|---|---|
| | silicon oxide | etch | Si₃N₄ etch | silicon | Selectivity |
| | etch rate/ | rate/ | rate/ | oxide:poly- | silicon |
| Solution | Å min⁻¹ | Å min⁻¹ | Å min⁻¹ | Si | oxide:Si₃N₄ |
| G1 | 285.4 | 1.07 | 2.28 | 267:1 | 125:1 |
| G2 | 277.7 | 1.15 | 2.58 | 241:1 | 108:1 |
| F4 | 295.75 | 1.20 | 2.49 | 246:1 | 118:1 |
| F5 | 287.25 | 1.20 | 2.57 | 239:1 | 112:1 |

Although composition G1 did not provide as high a silicon oxide etch selectivity as composition F1 (combination of 15 wt. % DPGBE and 5 wt. % DPGPE in 5 wt. % 3:1 NH₄F:HF base composition), the G1 composition was chosen as the preferred base composition because of ease of manufacturing associated with the use of just one chelator as well as the aforementioned lower CoSi₂ corrosiveness due to the lower fluoride concentration.

### Example 8

To further limit corrosion of the CoSi₂ interconnector material, various corrosion inhibitors, reducing agents and passivators were included in the G1 base composition and the blanketed wafer etch rates determined. In addition, voltage induced CoSi₂ galvanic corrosion was used to identify the preferred passivator of the CoSi₂ interconnector material.

A 4 wt. % 3:1 NH₄:HF composition including 15 wt. % DPGBE and ethylene glycol was selected as the base formulation. The samples tested were 1 cm² blanketed CoSi₂ substrates, which were first measured using the 4-point probe measurement technique to determine the thickness of the substrate as a function of conductivity. A regression curve was generated and the thickness of the CoSi₂ determined as a function of conductivity to derive the etch rate of CoSi₂ in each composition.

The anhydrous compositions tested (H1-H7), each of which included 4 wt. % 3:1 NH₄F:HF and 15 wt. % DPGBE, are listed hereinbelow in Table 14.

TABLE 14
Anhydrous compositions H1-H7.

| | 3-amino-9- | | Ascorbic | |
|---|---|---|---|---|
| | mercapto-1,2,4- | 5-amino-1,3,4- | acid | |
| | triazole | thiadiazole-2-thiol | (reducing | |
| Solution | (passivator)/wt. % | (inhibitor)/wt. % | agent)/wt. % | EG/wt. % |
| H1 | 0.1 | 0 | 0 | 80.9 |
| H2 | 0.2 | 0 | 0 | 80.8 |
| H3 | 0 | 0.1 | 0 | 80.9 |
| H4 | 0 | 0.2 | 0 | 80.8 |
| H5 | 0 | 0 | 0.1 | 80.9 |
| H6 | 0 | 0 | 0.3 | 80.7 |
| H7 | 0 | 0 | 0.5 | 80.5 |

The CoSi₂ thickness etched by anhydrous compositions H1-H7 at 20° C. or 30° C. are tabulated in Table 15 and compared to G1 (devoid of passivator, reducing agent or inhibitor) at 20° C. or 30° C.

TABLE 15
Etch rates of CoSi₂ using compositions G1 and H1-H7.

| | | | | | Thick- |
|---|---|---|---|---|---|
| | | | | | ness |
| | | | Thickness | Thickness | etched |
| | | Additional | etched in | etched in | in |
| Solution | Temperature | species | 1 min/Å | 2 min/Å | 3 min/Å |
| G1 | 20° C. | — | 14.73 | 22.47 | 40.76 |
| | 30° C. | — | 28.04 | 38.85 | 44.62 |
| H1 | 20° C. | 0.1 passivator | 13.70 | 27.14 | 36.70 |
| H2 | 20° C. | 0.2 passivator | 12.28 | 31.72 | 31.93 |
| H3 | 20° C. | 0.1 inhibitor | 17.52 | 34.98 | 34.63 |
| H4 | 20° C. | 0.2 inhibitor | 21.31 | 20.50 | 27.15 |
| H5 | 20° C. | 0.1 reductant | 8.53 | 25.26 | 25.38 |
| H6 | 20° C. | 0.3 reductant | 7.55 | 20.85 | 27.39 |
| H7 | 20° C. | 0.5 reductant | 7.75 | 21.7 | 25.47 |
| | 30° C. | 0.5 reductant | 32.25 | 35.45 | 35.45 |

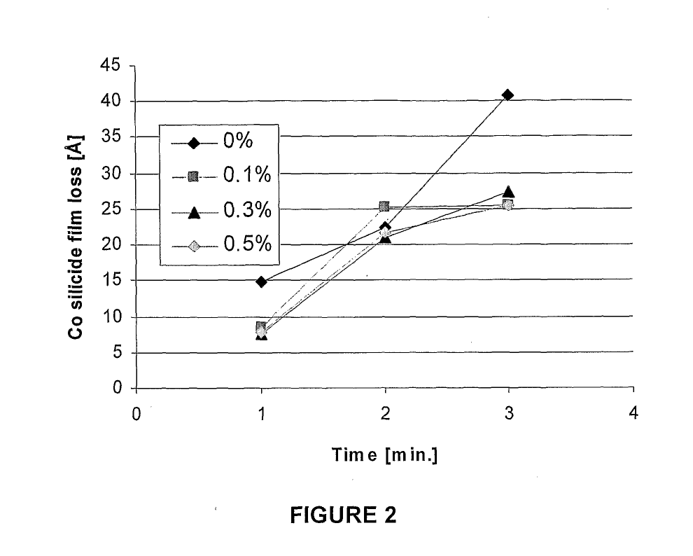

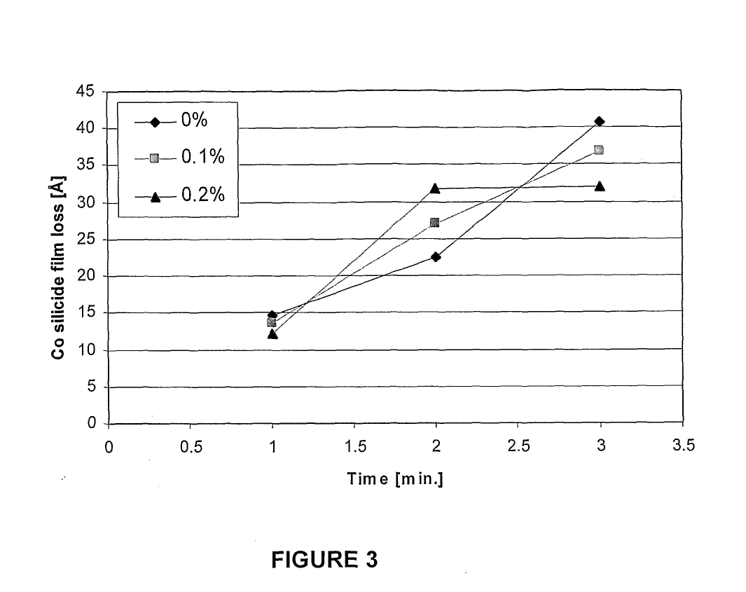

Referring to Table 15 and FIGS. 2 and 3, it can be seen that among the passivators, inhibitors and reducing agents evaluated, 0.3 wt. % and 0.5 wt. % reducing agent inhibited the CoSi₂ etch better than the other tested species.

Thereafter, the voltage induced CoSi₂ corrosion in 200 g base composition G1 having 0.3 wt. % reducing agent (ascorbic acid) and 1 wt. % IDA was determined electrochemically at 20° C. using a blanket CoSi₂ wafer as the working electrode, a Pt counter electrode and an Ag/AgCl reference electrode. It was determined that the CoSi₂ corrosion data as a function of the passivator (i.e., IDA) was better than that of the reducing agent.

### Example 9

As a result of Example 8, other passivators were added to the base composition and the rate of CoSi₂ corrosion determined.

The anhydrous compositions tested (J1-J3), each of which included 4 wt. % 3:1 NH₄F:HF and 15 wt. % DPGBE, are listed hereinbelow in Table 16.

TABLE 16
Anhydrous compositions J1-J3.

| Solution | 1,3-PDTA/wt. % | EDTA/wt. % | IDA/wt. % | EG/wt. % |
|---|---|---|---|---|
| J1 | 1 | 0 | 0 | 80 |
| J2 | 0 | 1 | 0 | 80 |
| J3 | 0 | 0 | 2 | 79 |

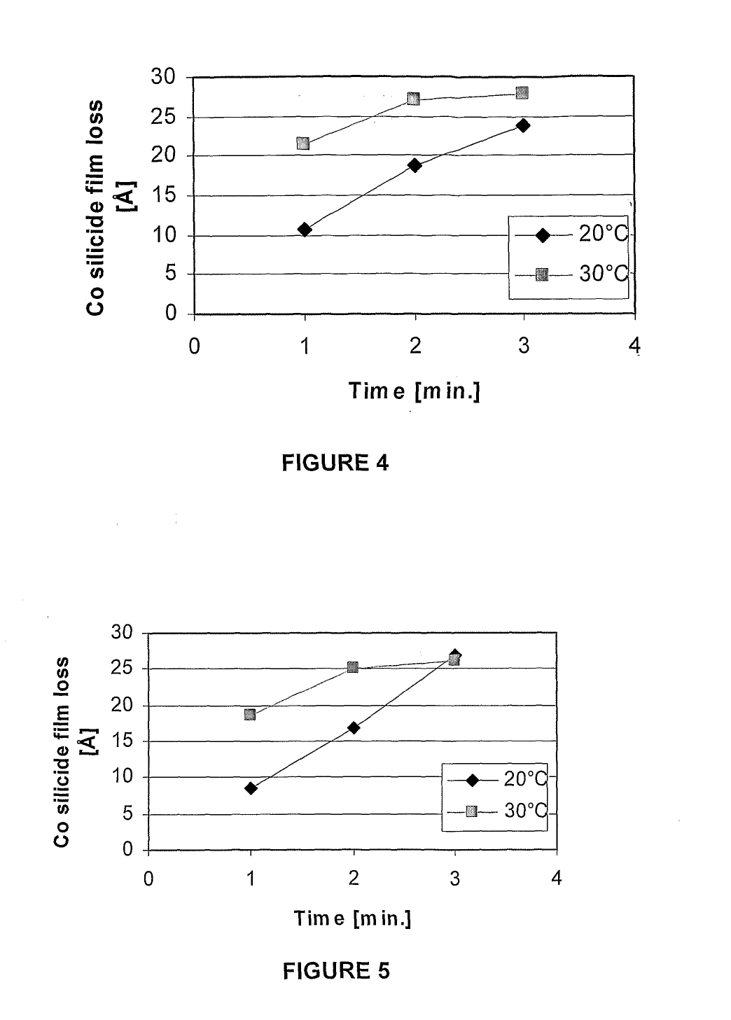

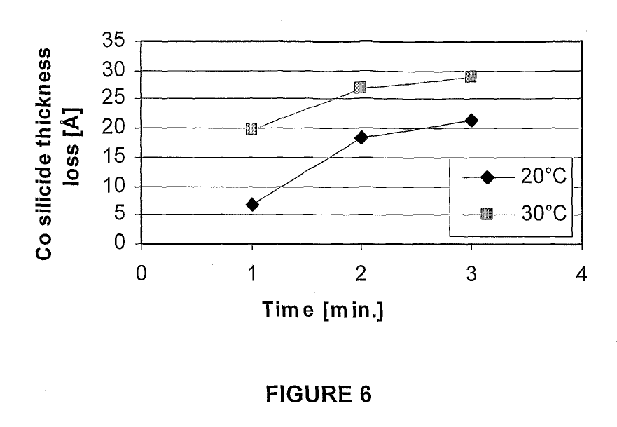

The CoSi₂ etch rates of anhydrous compositions J1-J3 at 20° C. or 30° C. are tabulated in Table 17 and illustrated in FIGS. 4, 5 and 6, respectively.

TABLE 17
Etch rates of CoSi₂ using compositions J1-J3.

| | | | Thickness | Thickness | Thickness |
|---|---|---|---|---|---|
| | | | etched in | etched in | etched in |
| Solution | Temperature | Passivator | 1 min/Å | 2 min/Å | 3 min/Å |
| J1 | 20° C. | 1,3-PDTA | 10.81 | 18.82 | 23.86 |
| | 30° C. | | 21.44 | 26.95 | 27.87 |
| J2 | 20° C. | EDTA | 8.49 | 16.75 | 26.77 |
| | 30° C. | | 18.75 | 24.96 | 26.24 |
| J3 | 20° C. | IDA | 6.96 | 18.39 | 21.28 |
| | 30° C. | | 19.73 | 26.79 | 28.84 |

Importantly, formulation J3 was diluted with water to make a 20:1 water:J3 composition and the pH was determined to be 4.45. Notably, the pH of a 20:1 water:J3 composition in the absence of passivator and chelator is 4.44.

Accordingly, while the invention has been described herein in reference to specific aspects, features and illustrative embodiments of the invention, it will be appreciated that the utility of the invention is not thus limited, but rather extends to and encompasses numerous other aspects, features, and embodiments. Accordingly, the claims hereafter set forth are intended to be correspondingly broadly construed, as including all such aspects, features, and embodiments, within their spirit and scope.

1. A gate spacer oxide material removal composition, comprising at least one organic solvent, at least one chelating agent, and a base fluoride:acid fluoride component having a ratio of about 1:1 to about 10:1, wherein the removal composition is substantially devoid of water, and wherein said removal composition is suitable for selectively removing gate spacer oxide material relative to both polysilicon and silicon nitride from a microelectronic device having such material thereon.

2.-3. (canceled)

4. The removal composition of claim 1, wherein the at least one organic solvent comprises a species selected from the group consisting of ketones, ethers, amines, amides, sulfur-containing solvents, alcohols, glycols, polyglycols, and combinations thereof.

5. The removal composition of claim 1, wherein the at least one organic solvent comprises a compound selected from the group consisting of acetone, 2-butanone, 2-pentanone, 3-pentanone, tetrahydrofuran, monoethanolamine, triethanolamine, triethylenediamine, methylethanolamine, methyldiethanolamine, pentamethyldiethylenetriamine, dimethyldiglycolamine, 1,8-diazabicyclo[5.4.0]undecene, aminopropylmorpholine, hydroxyethylmorpholine, aminoethylmorpholine, hydroxypropylmorpholine, diglycolamine, N-methylpyrrolidinone (NMP), N-octylpyrrolidinone, N-phenylpyrrolidinone, cyclohexylpyrrolidinone, vinyl pyrrolidinone, formamide, dimethylformamide, acetamide, dimethylacetamide, tetramethylene sulfone, dimethyl sulfoxide, ethanol, propanol, butanol, ethylene glycol, propylene glycol (1,2-propanediol), neopentyl glycol, benzyl diethylene glycol (BzDG), diethylene glycol and higher polyethylene glycols, dipropylene glycol and higher polypropylene glycols, glycol ethers, polyglycol ethers, glycerol, and combinations thereof.

6. (canceled)

7. The removal composition of claim 1, wherein the at least one chelating agent comprises a compound selected from the group consisting of butyl carbitol, polyethylene ethers (PEGs), diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether (TPGME), propylene glycol n-propyl ether, dipropylene glycol n-propyl ether (DPGPE), tripropylene glycol n-propyl ether, propylene glycol n-butyl ether, dipropylene glycol n-butyl ether (DPGBE), tripropylene glycol n-butyl ether, propylene glycol phenyl ether (phenoxy-2-propanol), and combinations thereof.

8.-9. (canceled)

10. The removal composition of claim 1, further comprising at least passivator, wherein the at least one passivator comprises a species selected from the group consisting of triazoles, thiazoles, tetrazoles, imidazoles, phosphates, diols, azines, glycerols, amino acids, carboxylic acids, alcohols, amides, quinolines, and combinations thereof.

11. The removal composition of claim 10, wherein the at least one passivator comprises a compound selected from the group consisting of benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, thiazoles, tetrazoles, imidazoles, phosphates, thiols, 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, indiazole, glycerols, amino acids, carboxylic acids, alcohols, ethylenediaminetetraacetic acid (EDTA), 1,2-cyclohexanediamine-N,N,N′,N′-tetraacetic acid (CDTA), 1,3-propylene-diamine-N,N,N′,N′-tetraacetic acid (1,3-PDTA), guanine, adenine, glycine, glycerol, thioglycerol, nitrilotriacetic acid, salicylamide, iminodiacetic acid (IDA), benzoguanamine, melamine, thiocyranuric acid, anthranilic acid, gallic acid; ascorbic acid; salicylic acid; 8-hydroxyquinoline, 5-carboxylic acid-benzotriazole, 3-mercaptopropanol, boric acid, and combinations thereof.

12.-13. (canceled)

14. The removal composition of claim 1, wherein the base fluoride:acid fluoride ratio is about 3:1 to about 5:1.

15. The removal composition of claim 1, wherein the base fluoride:acid fluoride component comprises ammonium fluoride and ammonium bifluoride.

16. The removal composition of claim 1, wherein the selectivity of gate spacer oxide material relative to polysilicon is about 100:1 to about 300:1.

17. The removal composition of claim 1, wherein the selectivity of gate spacer oxide material relative to silicon nitride is about 75:1 to about 150:1.

18. The removal composition of claim 1, wherein the pH is in a range from about 3 to about 6 when measured at a 20:1 dilution of water-to-removal composition.

19. (canceled)

20. The removal composition of claim 1, wherein the removal composition further comprises gate spacer oxide residue.

21. The removal composition of claim 20, wherein the microelectronic device comprises cobalt silicide.

22. The removal composition of claim 21, wherein the etch rate of CoSi₂ is about 1 Å min⁻¹ to about 15 Å min⁻¹.

23. The removal composition of claim 10, wherein said composition comprises ethylene glycol, DPGBE, iminodiacetic acid and a base fluoride:acid fluoride component having a ratio of about 3:1.

24. A kit comprising, in one or more containers, gate spacer oxide material removal composition reagents, wherein said removal composition comprises at least one organic solvent, at least one chelating agent, a base fluoride:acid fluoride component having a ratio of about 1:1 to about 10:1, and optionally at least one passivator, and wherein the kit is adapted to form the removal composition suitable for selectively removing gate spacer oxide material relative to both polysilicon and silicon nitride from a microelectronic device having such material thereon.

25. A method of removing gate spacer oxide material from a microelectronic device having said material thereon, said method comprising contacting the microelectronic device with a removal composition for sufficient time to at least partially remove said gate spacer oxide material from the microelectronic device, wherein the removal composition includes at least one organic solvent, at least one chelating agent, and a base fluoride:acid fluoride component having a ratio of about 1:1 to about 10:1, wherein said removal composition is substantially devoid of water, and wherein said removal composition is suitable for selectively removing gate spacer oxide material relative to both polysilicon and silicon nitride from a microelectronic device having such material thereon.

26. The method of claim 25, wherein said contacting comprises conditions selected from the group consisting of time in a range from about 1 minute to about 30 minutes; temperature in a range of from about 10° C. to about 50° C.; and combinations thereof.

27. (canceled)

28. The method of claim 25, wherein the microelectronic device comprises a gate electrode.

29.-31. (canceled)

32. The method of claim 25, further comprising rinsing the microelectronic device with deionized water following contact with the removal composition.

33.-35. (canceled)
